(19) United States
(12) Patent Application Publication
(10) Pub. No.: US 2024/0150528 A1
(43) Pub. Date: May 9, 2024

(54) PRINTABLE HYDROPHILIC AND VISCOELASTIC SILICONE MATERIAL AND METHOD OF MANUFACTURING SAME

(71) Applicants: Xiaowu (Shirley) Tang, Waterloo (CA); Hossein Golzar, Waterloo (CA)

(72) Inventors: Xiaowu (Shirley) Tang, Waterloo (CA); Hossein Golzar, Waterloo (CA)

(21) Appl. No.: 18/385,950

(22) Filed: Nov. 1, 2023

Related U.S. Application Data
(60) Provisional application No. 63/475,328, filed on Nov. 1, 2022.

(51) Int. Cl. C08J 3/24; B33Y 70/10; C08K 5/09

(52) U.S. Cl. CPC C08J 3/24; B33Y 70/10; C08K 5/09; C08J 2383/08; C08J 2401/02

(57) ABSTRACT

The disclosure is directed at a hydrophilic silicone material with tunable viscoelastic features for forming a three-dimensional object that includes a hydrophilic polymer matrix; at least one cross-linking material; and at least one photoinitiator.

### CROSS-REFERENCE TO OTHER APPLICATIONS

The disclosure claims priority from U.S. Provisional Application No. 63/475,328 filed Nov. 1, 2022 which is hereby incorporated by reference.

### FIELD

The disclosure is generally directed at three-dimensional (3D) printing and, more specifically, at a printable hydrophilic and viscoelastic silicone material and method of manufacturing same.

### BACKGROUND

Due to advances in additive manufacturing, three-dimensional (3D) printing provides an opportunity to fabricate complex structures layer by layer allowing 3D printing to more precisely mimic different structures, such as, but not limited to articular cartilage (AC) structures. For the printing of AC structures, microextrusion (ME)-based 3D printing is considered due to its ease of operation and capability of using multiple inks with different viscosities; however, developing ink formulations to replicate human AC with matching mechanical features is still considered a major challenge.

Silicone elastomers have been widely utilized in different biomedical applications due to their features such as flexibility, adaptability, and biocompatibility, but the slow curing speed, low viscosity, and hydrophobicity of existing silicones are challenges that hinder silicone applications.

Therefore, there is provided a novel printable hydrophilic and viscoelastic silicone elastomeric material and method of manufacturing same that overcomes disadvantages of current biomimetic 3D printable inks.

### SUMMARY

The disclosure is directed at a novel hydrophilic silicone-based elastomeric ink and method for fabricating the silicone-based ink. In one embodiment, the disclosure is directed at a hydrophilic and rapidly curing silicone-based ink with tunable mechanical characteristics suitable for 3D printing, such as, but not limited to, 3D microextrusion printing. The ink can also be used to prepare structures using other manufacturing methods such as, but not limited to, injection molding, micro molding, rotational molding, casting, coating, CNC machining. In some embodiments, the ink of the disclosure may be used for printing 3D human articular cartilage (HAC) substitutes, with a biomimetic multizonal structure; in-vitro 3D printing of tissue/organ models such as for surgical planning and disease mechanism study; in-vitro 3D printing of personalized implants/grafts/tissue replacements; printing of a microfluidic device; printing of a substrate for cell culture or injecting/in-situ 3D printing of personalized tissue substitutes.

In one aspect of the disclosure, there is provided a fast-curing hydrophilic silicone material with tunable viscoelastic features for forming a three-dimensional object including a hydrophilic polymer matrix; at least one cross-linking material; and at least one photoinitiator.

In another aspect, the hydrophilic polymer matrix includes a polymer matrix; and a set of rheology modifiers. In a further aspect, the polymer matrix is a silicone elastomer. In yet a further aspect, the silicone elastomer is aminosilicone or polyurethane. In another aspect, the set of rheology modifiers include cellulose nanocrystal (CNC), anisotropic nanoparticles or cellulose nanofibers (CNF). In a further aspect, the set of rheology modifiers is between about 1% and about 7% by weight. In yet another aspect, the at least one cross-linking material is a photoinitiator or methacrylate anhydride (MA). In an aspect, the MA is between about 3% and about 5% by weight.

In another aspect of the disclosure, there is provided a method of manufacturing a fast curing hydrophilic silicone material including obtaining a hydrophilic polymer matrix; and mixing at least one cross-linking material with the hydrophilic polymer matrix.

In another aspect, obtaining a hydrophilic polymer matrix includes obtaining a silicone elastomer; and mixing a set of rheology modifiers with the silicone elastomer.

### DESCRIPTION OF THE DRAWINGS

Some embodiments of the present disclosure are illustrated as an example and are not limited by the figures of the accompanying drawings, in which like references may indicate similar elements and in which:

FIG. 1a is a schematic diagram of a printable 3D silicone material;

FIG. 1b is a schematic diagram of another embodiment of a printable 3D silicone material;

FIG. 1c is a schematic diagram showing a reaction between amine and anhydride;

FIG. 1d is a schematic diagram of free radial polymerization;

FIG. 2 is a flowchart showing one method of manufacturing a printable 3D silicone material;

FIG. 3a is a graph showing rheological properties of the different aminosilicone-CNC inks;

FIG. 3b is a graph showing ζpotential of pure aminosilicone at different pH;

FIG. 3c is a table showing a summary of power-law parameters, showing non-Newtonian behavior of SCM hybrid inks;

FIGS. 4a to 4c are charts showing rheological characterization of SCM hybrid inks;

FIG. 4d is a chart showing step-strain measurements of SCM hybrid inks;

FIG. 5a is a chart showing H-MNR spectra of pure aminosilicone (bottom) and SC3M3 ink (top);

FIG. 5b is a chart H-NMR spectra of pure aminosilicone, SC3M3, SC3M5, SC5M3, and SC5M5 hybrid inks;

FIG. 6 is a table showing degree of substitution of SCM hybrid inks of the disclosure;

FIGS. 7a to 7c show examples of the printability of the SCM hybrid inks of the disclosure;

FIG. 7d is a table showing printing parameters of the SCM inks of the disclosure;

FIG. 8a is a chart showing swelling kinetics of the SCM inks of the disclosure;

FIG. 8b is a wettability evaluation of the SCM inks of the disclosure;

FIGS. 8c and 8d shown compression stress-strain curves;

FIGS. 8e and 8f show compression moduli of the inks of the disclosure after 1 and 2 weeks of printing;

FIGS. 9a to 9f are graphs showing cyclic compression tests of the inks of the disclosure;

FIG. 10 is a schematic diagram showing the printing of a customized human-like articular cartilage; and

FIG. 11 is a chart showing cytocompatibility of the inks of the disclosure.

### DESCRIPTION OF THE EMBODIMENTS

The disclosure is directed at a hydrophilic and viscoelastic silicone material (which may be seen as a silicone-based ink) and a method of manufacture. In one embodiment, the disclosure is directed at a hydrophilic and UV-curable (fast-curable) silicone-based ink which may be used to 3D print a multilayered articular cartilage (AC) structure. Depending on the requirements of the item being printed, the stiffness of the ink may be controlled.

In order to prepare the hydrophilic and viscoelastic silicone material as an ink, the ink includes a shear-thinning property that allows it to be extruded through a pressurized nozzle and retain its original shape after printing. In some embodiments, the silicone material or silicon-ink is hydrophilic and ultraviolet (UV)-curable with tunable mechanical properties.

In one specific embodiment, the hydrophilic and viscoelastic silicone material includes a combination of a silicone elastomer such as aminosilicone, cellulose nanocrystal (CNC), methacrylate anhydride (MA), and a photoinitiator.

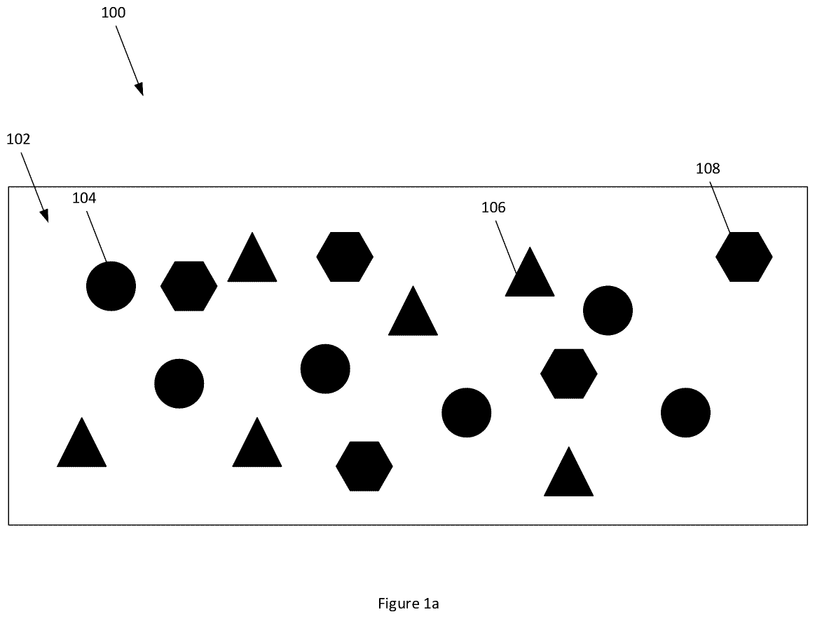

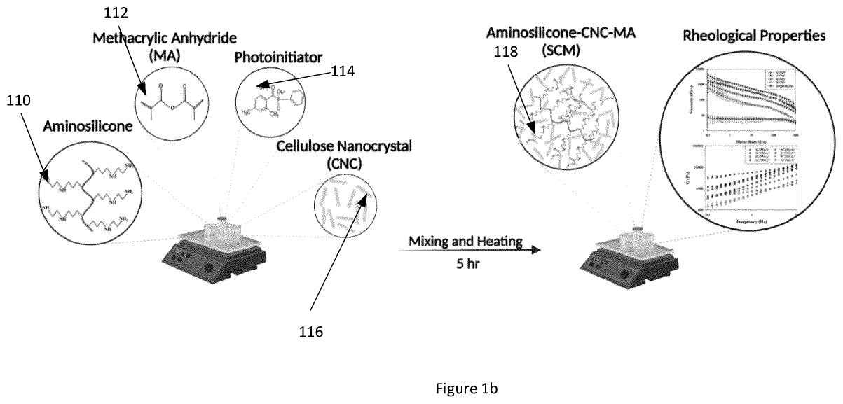

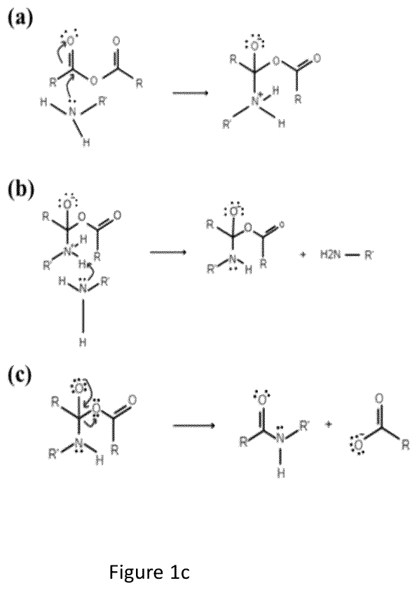

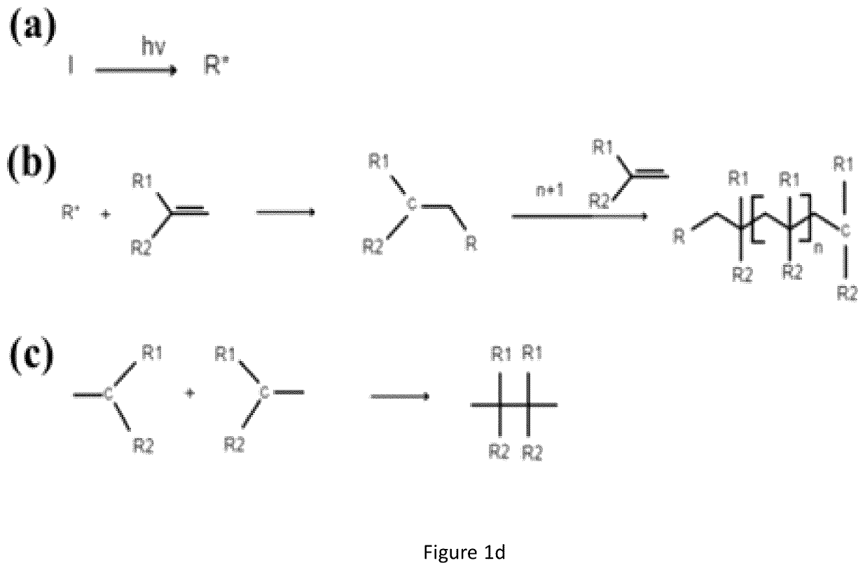

Turning to FIG. 1a, a schematic diagram of a hydrophilic and viscoelastic silicone material is shown. In one embodiment, the silicone material, or ink, 100 includes a polymer matrix 102, a set of rheology modifiers 104, at least one cross-linking material 106 and a photoinitiator 108. Although the CNC 104, the MA 106 and the photoinitiator 108 are shown as being multiple independent or distinct components, it is understood that manufacture or fabrication of the silicone material 100 requires the mixing of these different components 104, 106 and 108 with the polymer matrix 102.

In one embodiment, the polymer matrix 102 may be a silicone elastomer, such as, but not limited to, aminosilicone. In another embodiment, the set of rheology modifiers may be CNC. In another embodiment, the at least one cross-linking material may be MA. One example of a photoinitiator may include, but is not limited to, Lithium phenyl-2,4,6-trimethylbenzoylphosphinate (LAP). Aminosilicone does not possess a rheological feature, making it difficult to use by itself for ME 3D printing applications, however, the incorporation or inclusion of nano-sized rheology modifiers into the aminosilicone allows aminosilicone to overcome this problem.

In one specific embodiment, the CNC that is introduced into the polymer matrix is a hydrophilic nano-sized rheology modifier whereby the combination may be seen as a hydrophilic silicone elastomer or hydrophilic polymer matrix. CNC is selected due to its number of hydroxyl groups that induce a shear-thinning property within and improve mechanical strength of the polymer matrix. For this specific embodiment, at least one cross-linking material is MA.

After the components are mixed together, the silicone material 100 may then be placed into a reservoir such as a syringe which is attached to the 3D printer that can be used as an ink for the 3D printer. The silicone material, or ink, may then be used by the 3D printer to print a layered structured item or product, such as, but not limited to, an AC model.

When used in ME 3D printing, the combination of the MA and photoinitiator within the printable 3D silicone material 100 enables the ink to extrude through a ME 3D printer nozzle into the desired position which can then be rapidly cured. Simultaneously incorporating the CNC and MA enhances the mechanical strength of the 3D-printed item such as the AC model.

Turning to FIG. 1b, a schematic diagram of a specific embodiment of a printable 3D silicone material is shown. The silicone material 100 includes aminosilicone 110, MA 112, photoinitiator 114 and CNC 116. After mixing the components and then heating the mixture, such as for about 5 hours, the silicone material or silicone ink is produced and may be seen as aminosilicone-CNC-MA (SCM) 118.

In one embodiment of FIG. 1b, the silicone material was prepared by dispersing different concentrations of CNC, ranging from 1 to 7 wt %, in 2 mL of Milli-Q water, followed by mixing with aminosilicone (3 g). This may be seen as aminosilicone-CNC (SC) with 1 to 7 wt %. Then, various amounts of MA, ranging from 1 to 7 wt %, were added to the mixture to prepare the 3D silicone inks with different concentrations of CNC and MA. The resulting mixture was stirred at 80° C. in the dark for 3 hr with a closed cap to perform nucleophilic acyl substitution to the pendant amine functionalities in the silicone elastomer (aminosilicone). Water and excess MA was then removed from the mixture by stirring the mixture for 2 hr at 160° C. without the cap, followed by adding LAP (0.5 wt %) and stirring for another 1 hr at 90° C.

In some embodiments of manufacture, the methacryloyl group was grafted to the side chain of aminosilicone through an addition mechanism as schematically shown in FIG. 1c. As can be seen in this figure, this mechanism starts with an attack of the primary amine groups of aminosilicone on MA's carbonyl groups resulting in the formation of a tetrahedral intermediate. The second step of the mechanism is the elimination or removal of the leaving group, containing the second carbonyl group of the MA. This elimination or removal occurs by collapsing the tetrahedral intermediate leading to the reformation of the C═O carbonyl bond and a new acyl compound.

Furthermore, free radical polymerization, involving three different types of reactions: initiation, propagation, and termination, is responsible for providing the inks of the disclosure with an improved crosslinking characteristic. This is schematically shown in FIG. 1d. As can be seen in FIG. 1d, during the initiation reaction, UV irradiation of LAP generates the radicals for polymerization. After initiation, many monomers add to the propagating chain. The propagation reaction is eventually terminated by encountering two propagating chains that undergo disproportionation or coupling.

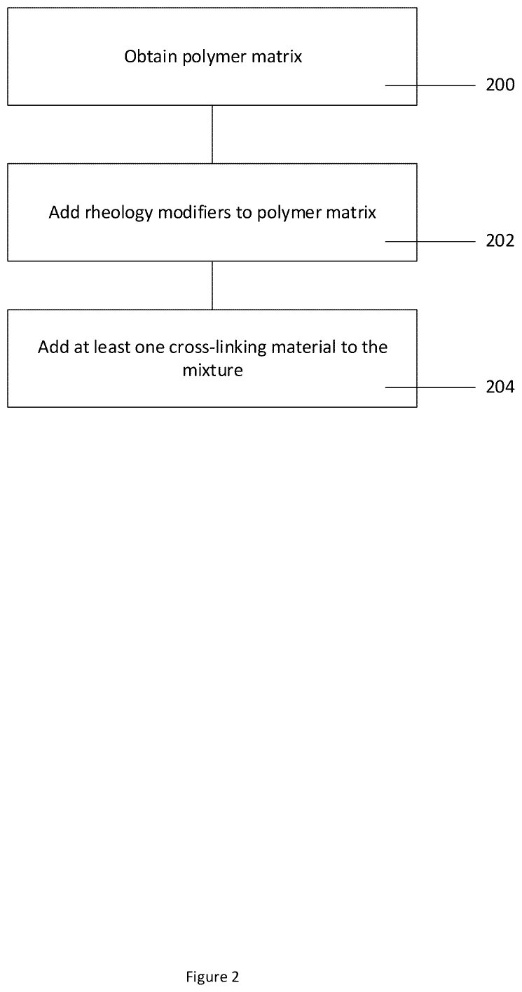

Turning to FIG. 2, a flowchart showing one method of manufacturing a printable 3D silicone material for use as an ink in 3D printing is provided. Initially, a polymer matrix is obtained (200). The polymer matrix may be pre-mixed or may be mixed based on a known list of ingredients. While different polymer matrixes are contemplated, in one specific embodiment, the polymer matrix is a silicone elastomer such as, but not limited to, aminosilicone or polyurethane.

Nano-sized rheology modifiers are then added to the polymer matrix (202). In one specific embodiment, the rheology modifiers are CNC since CNC come from a renewable source, have high mechanical strength and low cytotoxicity. Other examples of rheology modifiers include but are not limited to, anisotropic nanoparticles and cellulose nanofibers (CNF). The combination of the rheology modifiers and the polymer matrix may be seen as a hydrophilic silicone or hydrophilic polymer matrix. As such, in some embodiments, the combination (200) and (202) may be replaced with the process of obtaining a hydrophilic silicone or hydrophilic polymer matrix that may be pre-mixed.

In this specific embodiment, the amount of CNC that is added to the polymer matrix may be determined based on at least one of the properties of the polymer matrix, the properties of the CNC particles and/or the desired properties of the finished silicone material or silicone ink. Properties of the silicone material may include the rheological or desired properties of the hydrophilic silicone or aminosilicone-CNC (SC) inks.

At least one cross-linking material is then added to the polymer matrix and rheology modifier mixture (204). Depending on the desired crosslinking mechanism and properties of the final printable 3D silicone material or ink, different cross-linking materials may be added. In one specific embodiment, where the polymer matrix is aminisilicone and the rheology modifier is CNC, one of the at least one cross-linking materials may be any known acrylate such as MA. Selection of MA as a cross-linking material may elevate or increase a viscosity of the mixture over a shear rate range. This will be described in more detail below with respect to the experiments. In some embodiments, a second cross-linking material, such as, but not limited to, a photoinitiator can be added to the mixture. One example of a photoinitiator is LAP. Other examples include, but are not limited to, 2-hydroxy-1-[4-hydroxyethoxy)phenyl]-2-methyl-1-propanone (Irgacure 2959) and 2,4,6-trimethylbenzoyldiphenyl phosphine oxide (TPO).

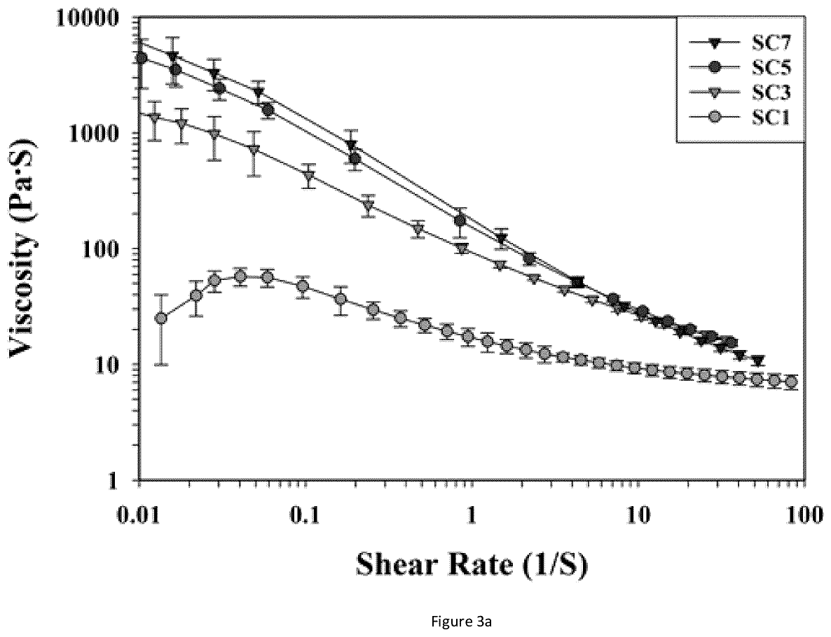

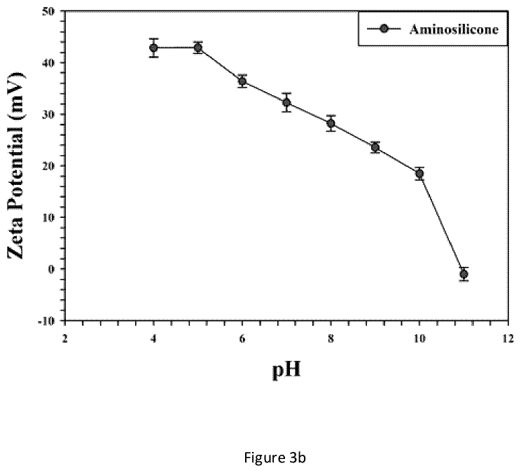

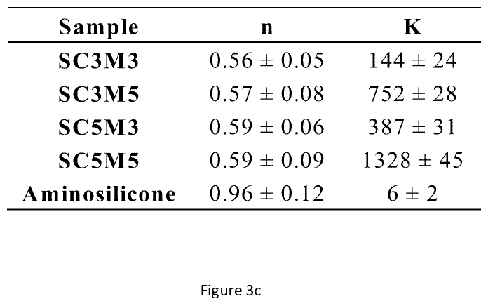

In experiments, printable 3D silicone materials or inks were fabricated using aminosilicone with different concentrations of CNC (from 1 to 7 wt %). The inclusion of a higher percentage of CNC improved both the static viscosity and the shear-thinning property of the CNC and polymer matrix mixture as shown in FIG. 3.

This is schematically shown in FIG. 3 which shows viscosity vs shear rate for different SC inks where SC1 represents an ink with a 1% by weight CNC concentration, SC3 represents an ink with a 3% by weight CNC concentration, SC5 represents an ink with a 5% by weight CNC concentration and SC7 represents an ink with a 7% by weight CNC concentration. While higher concentrations of CNC may be contemplated, at higher CNC concentrations, there was crystallization occurring which reduces the interaction between the polymer matrix and the CNC thereby reducing the benefits that are realized at CNC concentrations between 1 and 7 wt %. It is noted that the tested range of between 1 to 7 wt % should not be seen as limiting to the scope of CNC concentration.

The improving static viscosity and the shear-thinning property may be attributed to the interactions among the CNC particles themselves, as well as between the CNC particles and the polymer matrix. Based on ζ-potential measurement results (as schematically shown in the chart of FIG. 3b), it was noted that CNC particles repel each other due to their highly negative surface charge, resulting in good or improved dispersion within the polymer matrix.

When using aminosilicone as the polymer matrix, the aminosilicone wraps around the CNC particles through electrostatic attraction due to its positively charged amine groups. Therefore, when a shear stress is applied, the entangled CNC and aminosilicone network re-aligns and the mixture's viscosity decreases which is also a characteristic of the 3D printable silicone ink.

As discussed above, while the printable 3D silicone ink was determined to be usable at CNC concentrations between 1 wt % and 7 wt %, CNC concentrations of 3 and 5 wt % appeared to provide the best results and were used in further testing with the at least one cross-linking materials or cross-linking experiments. In these experiments, MA was the first cross-linking agent that was used.

In experiments, the incorporation of MA into the polymer matrix and CNC mixture (or SCmatrix) elevated the viscosity over the entire shear rate range (0.1-1000 s⁻¹) but had no significant effect on shear-thinning (as schematically shown in FIG. 1a).

To understand the correlation between viscosity (η) and shear rate (γ), a power-law equation has been used to fit the flow curves. The equation used for viscosity is:

η=K·γ⁽ⁿ⁻¹⁾ (1)

where K and n represent the consistency index and flow index, respectively. The flow index (n) is used to define the flow behavior of a fluid, where n>1, n=1, and n<1 represent shear-thickening, Newtonian, and shear-thinning flow respectively.

The derived n and K values for the aminosilicone-CNC-MA (SCM) inks are tabulated in FIG. 3c where wt % of a component is represented by the number following C or M. All the developed inks showed n values of less than 1, confirming the shear-thinning property induced by CNC incorporation. The consistency index also significantly increased (i.e., by 1 order) by increasing the MA concentration, demonstrating higher viscosities at a constant shear rate. This increase may be attributed to the formation of intermolecular hydrogen bonding between the carbonyl group of the grafted MA with either CNC or the secondary amine group of the aminosilicone, leading to a more tangled network. These changes can efficiently improve the printability of the aminosilicone-based inks by decreasing flow resistance at high shear rates during extrusion.

For the experiments, about 3 wt % and about 5 wt % of MA were used to prepare the printable 3D silicone inks because 1 and 7 wt % of MA respectively failed to cure under UV exposure due to a lack of crosslinking sites, and developed a highly viscose solution with aggregated CNC particles, however, it may still be possible to produce printable 3D silicone inks using MA weight percentages outside of the 3 to 5 wt % range.

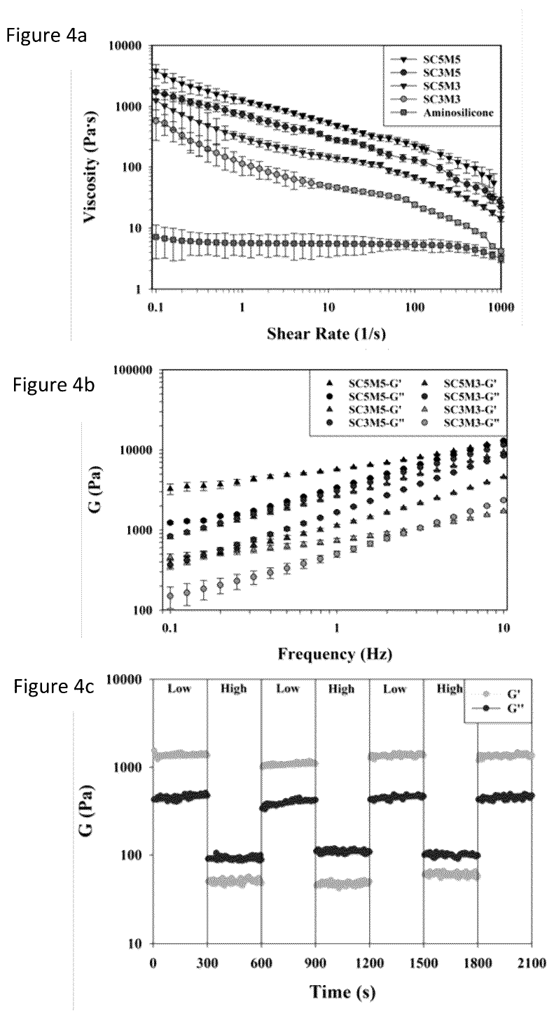

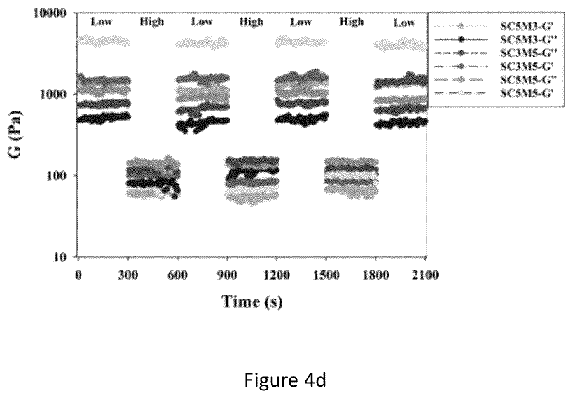

In testing, all of the aminosilicone-CNC-MA (SCM) inks not only possessed a noticeably higher static viscosity compared to pure aminosilicone but also showed a proper shear-thinning property. Results are shown in FIGS. 4a to 4d. FIGS. 4a to 4c are graphs showing rheological characterization of SCM hybrid inks where FIG. 4a shows flow curves of different inks and aminosilicone; FIG. 4b shows elastic (G′) and viscous (G″) moduli of different inks as a function of oscillatory frequency; FIG. 4c show step-strain measurements of SC3M3 over three cycles at 25° C. and FIG. 4d shows Step-strain measurements of SC3M5, SC5M3, and SC5M5 over three cycles at 25° C. For FIGS. 4c and 4d the error bars represent ±SD, n 3.

The SC3M3 (aminosilicone with 3 wt % CNC and 3 wt % MA) printable 3D silicone ink showed a viscosity close to 700 and 7 Pas at static state and 5 and 3 Pas at the shear rate of 1000 s-1, respectively (i.e., 2 orders lower for SC3M3). Furthermore, frequency sweep profiles showed that the elastic modulus G′ of all aminosilicone-based compositions was higher than their viscos modulus G″ at low frequencies, indicating a solid-like structure, while G′ overrode G″ at frequencies above 1 Hz. Additionally, the results showed that increasing the CNC and MA concentration resulted in the formation of a stronger network since the elastic modulus dramatically increased from 200 to 3000 Pa at 0.1 Hz for SC3M3 and SC5M5, respectively.

To investigate the self-healing behavior of the developed inks, step-strain experiments were performed. When the strain was switched between high and low (0.1 and 500%), all inks showed an inversion of elastic and viscose moduli under the high strain followed by quick recovery of the elastic modulus at low strain. The self-healing efficiencies of all inks were evaluated by performing three cycles of cyclic strain testing with 300-seconds intervals between tests (as shown in FIGS. 4c and 4d). The results indicated nearly 100% recovery. It was determined that this self-healing aspect of the printable 3D silicone ink may be rooted in the reversible and quick re-establishment of the electrostatic interactions between positively charged free primary amino groups that existed on the aminosilicone chain and the negatively charged CNC. Overall, the shear-thinning property and fast recovery of the developed aminosilicone-based inks make them suitable for ME printing.

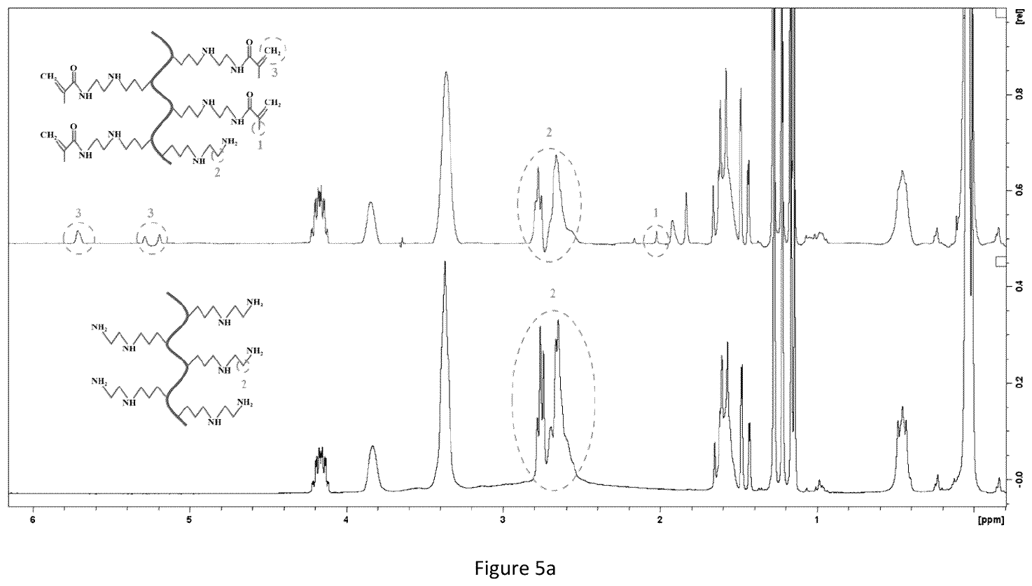

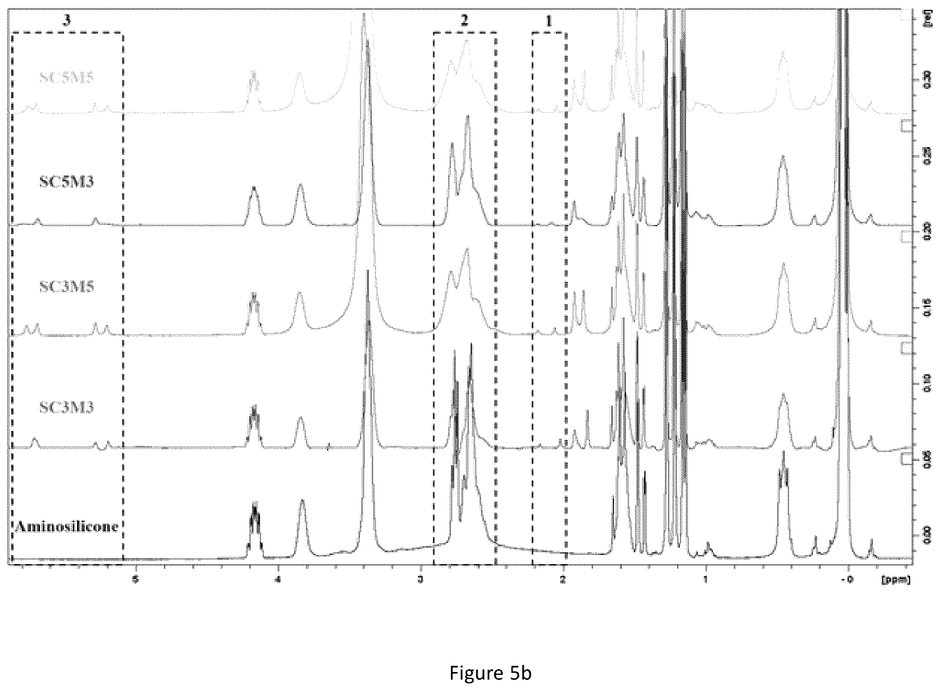

The successful grafting of the methacryloyl group to the aminosilicone chain was confirmed via H-NMR microscopy and a TNBS assay. The results are shown in FIG. 5a which is a chart showing H-MNR spectra of pure aminosilicone (bottom) and SC3M3 ink (top). As can be seen in FIG. 5a, there are four distinctive peaks at 1.9, 2.7, 5.3, and 5.8 ppm in the SC3M3 H-NMR spectrum (top chart), which correspond to methyl protons of methacrylamide grafts (1), methylene protons of unreacted aminoethylaminopropyl group (2) and acrylic protons of methacrylamide grafts (3). The decreased signal in peak (2) and the emergence of peaks (1 and 3) in the spectrum of SC3M3 indicate the successful grafting of the methacryloyl groups. The H-NMR spectra of all developed inks is shown in FIG. 5b.

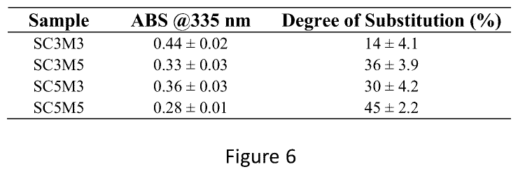

In another experiment, a TNBS (2,4,6-trinitrobenzene sulfonic acid) assay was performed to quantify the degree of substitution of the developed inks. TNBS is a highly sensitive and rapid test to quantify the free primary amines. As shown in the table of FIG. 6 (which shows degree of substitution for the listed SCM hybrid inks) increasing CNC and MA concentrations led to a higher degree of substitution, from 14% to 45% for SC3M3 and SC5M5, respectively. The TNBS results were in agreement with the results of the H-NMR spectrum.

The printability of the different SCM hybrid inks was evaluated in terms of extrudability, accuracy, homogeneity, resolution and shape fidelity.

While several factors may affect extrudability, such as printing parameters, ink viscosity, and shear-thinning properties, rheological measurement is considered an indirect method of investigating extrudability. As discussed above with respect to FIG. 3c, all developed inks had a flow index ‘n’ below 1, confirming their shear-thinning property.

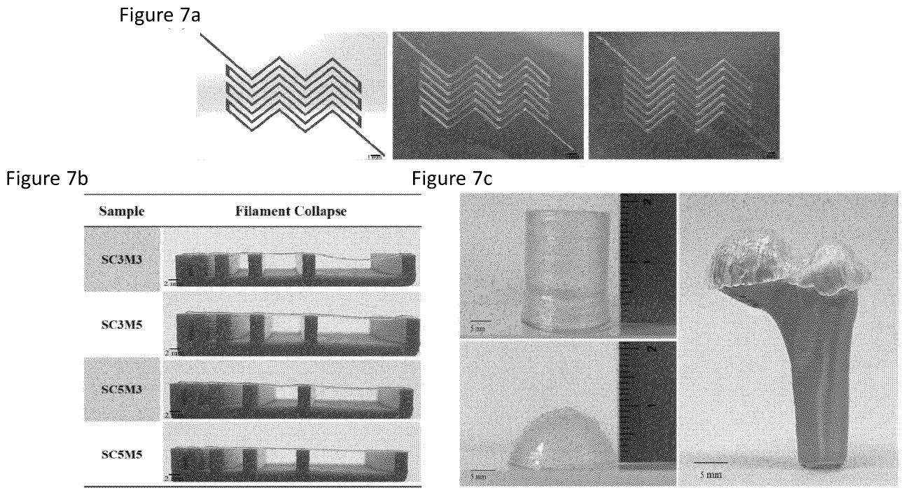

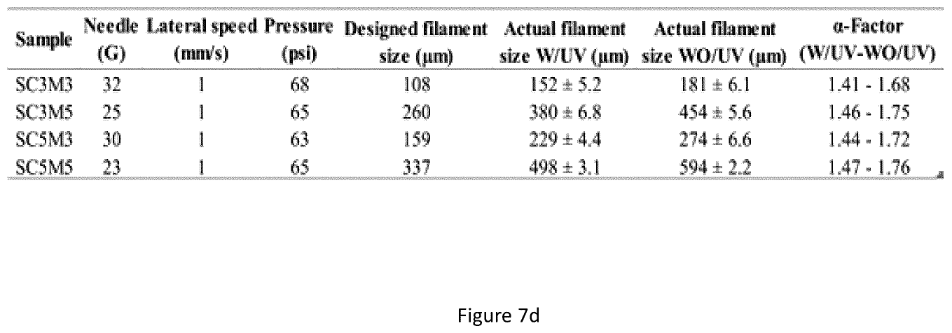

Printing accuracy is a parameter known to show the similarity of the printed structure to the designed one. Printing accuracy can be investigated along with homogeneity and resolution. To evaluate these parameters, a zig-zag pattern was designed, and the width of the printed filaments, with/without UV-exposure, was measured (as shown in FIG. 7a). As can be seen in FIG. 7a, although the width of the printed filaments differed slightly from the designed ones, the printed patterns were uniform and precisely mimicked the designed structure. When a viscoelastic ink extrudes through a nozzle, the diameter of the extruded fiber is greater than the nozzle diameter by a factor of ‘a’, a phenomenon called die-swelling. Many parameters such as nozzle diameter, material characteristics, and applied shear stress can affect the ‘a’ factor. The results show that there is no significant differences between SCM inks' ‘a’ factor. It was also noted that the incorporation of a goose neck UV light inside the 3D printer chamber significantly reduces filament spread and improves accuracy; for instance, the ‘α’ factor of SC3M3 decreased from 1.68 to 1.41, after UV exposure.

Horizontal resolution is considered an important factor in printing complex structures whereby a higher resolution can provide the opportunity to create more-accurate structures. Different nozzles with various inner diameters were used to test the developed inks determine the best-achievable resolution for each of the developed inks. As shown in FIG. 7a and the table in FIG. 7d, the SC3M3, SC3M5, SC5M3, and SC5M5 inks can be uniformly extruded from 32, 25, 30, and 23 G nozzles, respectively, by applying the pressure of 63 to 68 psi. The SC3M3 and SC3M5 ink, with their horizontal resolution of 152 and 229 μm, respectively, exhibit the highest resolution of all the extrudable silicone-based inks developed so far, since the highest resolution for silicone-based inks reported in the literature is 260 μm (25G nozzle).

Testing the shape fidelity of the ink is used to confirm the capability of an ink to retain its original shape after deposition. Different test may be used, however, in experiments testing the developed inks, filament collapse and height maintenance test were used. The results are shown in the photographs of FIG. 7b which show a filament collapse test of the different inks. To assess shape fidelity, the deflection area of the printed filament across gaps at various distances including 1, 2, 4, 8, and 16 mm was examined. As can be seen in FIG. 7b, increasing the concentration of CNC and MA led to a minimum or low deflection of the printed filaments. IT was also shown that almost all the SCM inks were able to bridge the gap between pillars, even up to 16 mm, by generating a straight filament. Among different ink formulations, the collapsed area of the SC3M3 was a bit higher, at a 16 mm distance value, which might be related to its lower crosslink density.

In order to demonstrate the rapid-curing and shape-retaining capabilities of the developed ink, a high aspect ratio cylindrical structure was 3D printed using the SC3M3 hybrid ink which was the weakest one compared to the other inks. The results are shown in the photographs of FIG. 7c which show the 3D printing of high-aspect ratio, overhanging and human-link AC (HAC) structures. As shown in FIG. 7c, the printed part had a height of 18.2 mm and a diameter of 20 mm without any cavities or voids. The cylinder wall thickness was approximately 1 mm and highly uniform throughout its height. Therefore, the aspect ratio of the printed cylinder was a remarkable 18:1. It is expected that the inks of the disclosure have a capability of printing even taller structures; however, the maximum height possible with the 3D printer that was used in the experiments was 19 mm. It should also be noted that all structures were printed under in-situ UV exposure. The results confirmed that the fast-paced curing feature of the developed inks—approximately 2-3 seconds—can support the creation of high aspect ratio structures through layer-by-layer printing with no cavities or voids between the layers.

Besides tall structures, hemispherical or dome structures are considered to be among the most challenging shapes for ME printing. The fast-paced curing characteristic of the inks of the disclosure offers the opportunity to print such structures without using sacrificial supports. As can be seen in FIG. 7c, the SC3M3 hybrid ink was used to print a hollow domed structure with a 20 mm diameter, 10 mm height, and a uniform consistency. This confirms that creating overhanging constructs with a gradual curvature shape may be improved or performed using the inks of the disclosure.

In addition, to assess the capability of our ink in fabricating human-like structures, a femur head's AC was also printed using SC3M3 hybrid ink. As shown in FIG. 7c, the printed AC precisely covers the femur head without any defect. Therefore, it was concluded that the inks of the disclosure possess excellent printability characteristics in terms of extrudability, accuracy, homogeneity, resolution, and shape fidelity.

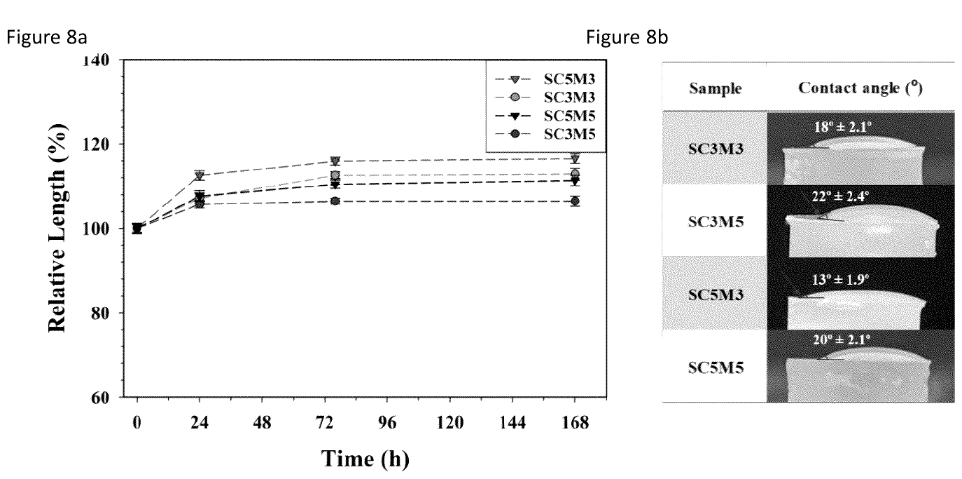

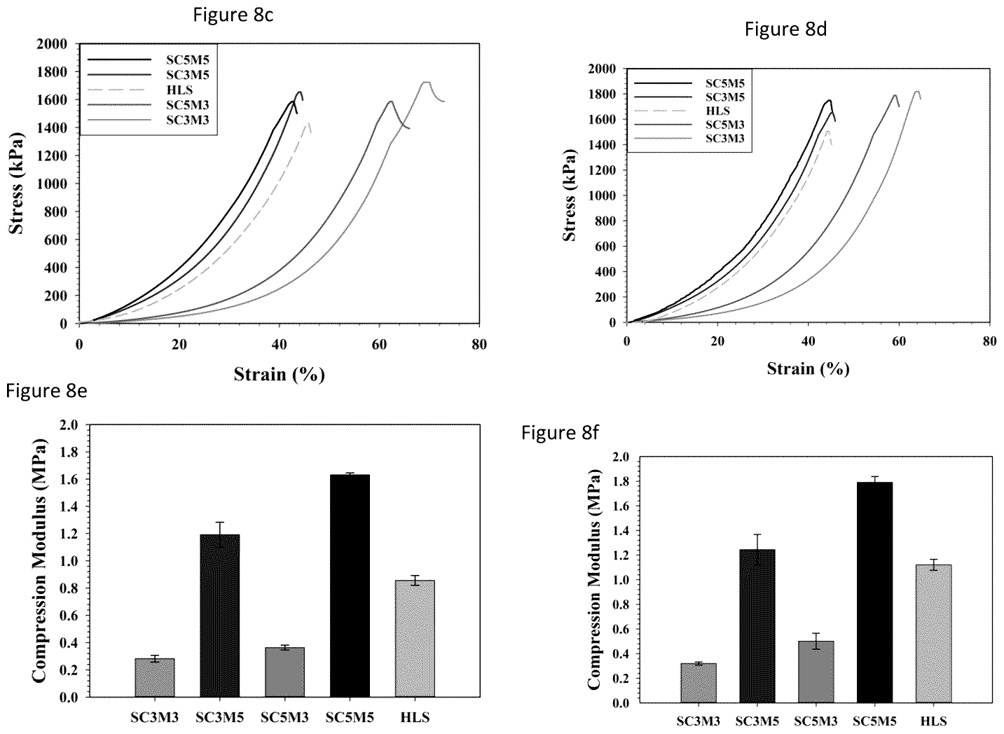

Another important characteristic for an ink that is used in the printing of tissue engineering applications relates to the swelling of developed inks since they can significantly affect the mechanical feature of the printed constructs over the time. The swelling feature of 3D printed constructs were examined in phosphate buffered saline (PBS), as shown in FIG. 8a. All the inks of the disclosure showed a quick swelling during the first 24 hr and reached the state of equilibrium swelling within 48 hr. Increasing the MA concentration within the silicone material or ink leads to less swelling. For instance, during the first 24 hr, the relative length of the SC3M3 expanded by 12%, while that of SC3M5 expanded by only 6%. A similar trend was observed for SC5M3 and SC5M5. By increasing the MA concentration more amine groups were replaced by hydrophobic methacryloyl groups, resulting in higher crosslinking density and a more-tangled polymer network. This strengthens the hydrophobic nature of the aminosilicone and limits the matrix network expansion, thereby decreasing the water retention of the printed constructs. On the other hand, the addition of the CNC, which possesses abundant hydrophilic groups such as hydroxyl, improves the water absorbance of the polymer network. Therefore, the swelling ratio of the inks of the disclosure was tunable by altering their compositions.

One of the advantages of the disclosure is that it may address one of the main challenges hindering the application of surgically substitutable silicones whereby the body often triggers an immune response against them, called the foreign body response, which isolates the substitutes. The immune response around the substitutes can be controlled by modifying the material's surface properties such as hydrophilicity. As hydrophilic surfaces are more favorable for cells growth and adherence, they may provide cells with a suitable substrate for attachment via adhesive proteins such as vitronectin. Therefore, the wettability of our printed structures and aminosilicone-methacrylate (SM) gels was evaluated as a contact angle (CA) and tabulated. The results are shown in FIGS. 8b to 8f. As can be seen in FIG. 8b, the CA values of the printed structures are below 90°, confirming their hydrophilic surfaces. Although the incorporation of the CNC can improve the hydrophilic feature of the printed structures, adding MA slightly increased the CA values, due to the hydrophobic nature of the MA groups. Therefore, for long term applications, it was expected that inducing anti-immune features such as hydrophilicity by modifying the nature of the substitutable silicone-based materials may be of more benefit than surface modification methods. The results are in agreement with those of the swelling ratio test that was performed on the inks of the disclosure.

The constructs printed with the inks of the disclosure were investigated in terms of mechanical strength, and their compression stress/strain curves are depicted in FIGS. 8c to 8f. Increasing the concentration of MA and CNC can significantly improve the mechanical strength; for instance, the compression moduli for SC3M3, SC3M5, SC5M3, and SC5M5 are 0.25, 0.96, 0.38, 1.32 MPa, respectively, demonstrating approximately 1.5-, 3.84- and 5.28-fold increases in the compression modulus by raising CNC, MA, and CNC-MA concentration from 3 to 5%, respectively. This improvement can be related to the presence of CNC particles and the macromolecular chain entanglements within the polymer matrix. Once compression stress is applied on the printed structure, the polymer network transfers the stress through polymer chains to CNC particles. This mechanism hinders the crack propagation phenomenon at high deformation. Besides the polymer-CNC entanglement effect, the energy of the applied compression stress can be dissipated by forming reversible hydrogen bonds between CNC particles and aminosilicone chains. CNC particles may also affect energy dissipation by aligning themselves in the direction of applied stress whereby the CNC-particle movement may result in further energy dissipation and higher stress cracking resistance. Therefore, the effect of interfacial noncovalent bonding, such as hydrogen bonding, polymer-chain covalent crosslinking, and the entangle-disentangle mechanism within the polymer network significantly improves the stiffness of the printed structures. It was noted that increasing the MA concentration leads to a higher crosslinked polymer network, which in turn results in lower elasticity and ultimate strain. For instance, the ultimate strain for SC3M3 is approximately 60%, which is 20% more than that of SC3M5.

For the printing of a HAC, there is a need for a combination of elasticity and stiffness that precisely mimics the zonal structure of AC as an AC contains different zones—superficial, transitional, and deep—respectively making up to 10-20%, 40-60%, and 30% of the AC's thickness. Each zone plays a different role; the superficial zone, which comes into direct contact with synovial fluid, provides most of the tensile features of AC. Therefore, the printed AC needs to be more elastic to be able to resist the minor shear, compressive, and stress forces that constantly affect AC during humans' daily activities. The second zone is transitional, and acts as a bridge between the superficial and deep zones. It is considered as a borderline for resisting major compressional forces, meaning that it needs to be stiffer than the superficial zone. The deep layer contains bigger collagen fibrils, allowing it to bear the greatest compression forces. Using the developed inks, the viscoelastic part of AC was printed whereby the resulting three-zone HAC design precisely mimics AC's zonal structure. Since the compression modulus of AC varies from 0.24 to 1 MPa, the SC3M3, SC3M5, and SC5M5 inks were selected for printing each layer. SC3M3 was used to print the superficial zone since it provides higher elasticity and ultimate strain compared to other inks, due to its lower crosslinking degree. In addition, SC3M5 and SC5M5 were used to print the middle and deep zones, respectively, because they can bear high loads by providing the HAC with sufficient stiffness. As shown in FIGS. 8d and 8f, the compression stress/strain curve of the printed HAC at lower strain behaves more like SC3M3, while at higher strain, it moves closer to the SC3M5 and SC5M5 curves. The results also show that the ultimate strain of the HAC slightly improved compared to that of SC3M5 and SC5M5.

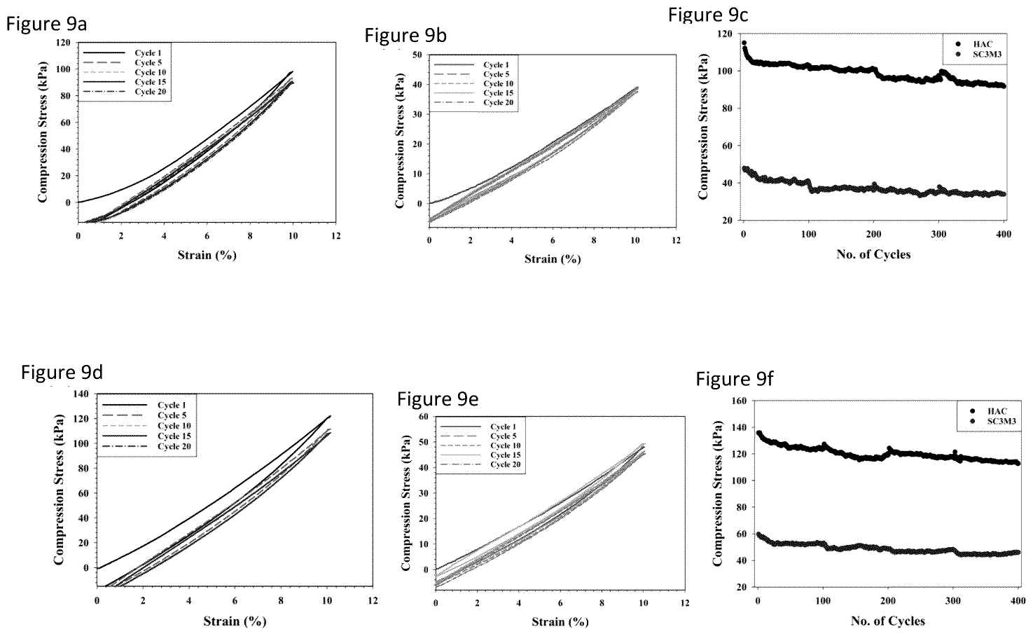

To investigate the effect of repeated compressive cyclic loading on the mechanical stability of the printed HAC, cyclic unconfined compression tests were performed. The results are shown in FIGS. 9a to 9f which graphs showing cyclic compression tests of the inks of the disclosure at different time points. Cyclic stress—strain curves under a continuous 20-cycles compression test of 3D printed cylinders of HAC (FIG. 9a) and SC3M3 (FIG. 9b) inks after 1 week as well as HAC (FIG. 9d) and SC3M3 (FIG. 9e) after 2 weeks are shown. FIGS. 9c and 9f shown Compression stress for 3D printed cylinder, using HAC and SC3M3 at a strain of 10% strain over 400 cycles, after 1 week and 2 weeks, respectively. The gel was relaxed at each 100 cycles for 40 min.

Since the diurnal and post-activity strains on AC are usually in the range of 0 to 10% and 5 to 15%, respectively, the printed HAC was compressed up to 10% strain at a rate of 0.05 mm s⁻¹, and then released back to its original height at the same rate for 20 cycles. As can be seen in FIG. 9b, the printed HAC showed a nonlinear stress-strain curve in which the hysteresis area decreases when the cycling number was increased from 1 to 5. This hysteresis may be rooted in the presence of CNC in the polymer matrix. When stress was applied to the polymer chains, the chains try to compress, and CNC particles try to dissipate the crack energy by sacrificing their hydrogen bonds with the polymer chains. Once the compression stress is removed, the polymer chains tend to rapidly regain their original shapes, but the CNC particles can not move at the same pace which may result in interfacial friction between CNC particles and polymer chains, which in turn dissipates some energy. In addition, after the fifth cycle, the stress-strain curves overlap to a large extent, and the compression moduli are likely to remain constant up to the twentieth cycle, meaning that the printed HAC becomes softer than its original structure. In order to providing an insight into how multizonal structure printing affected the mechanical behaviors of the inks of the disclosure, cyclic tests were conducted on the printed structure using SC3M3 (FIG. 9e). As shown in FIG. 9e, although the stress-strain curve of SC3M3 is similar to that of HAC in terms of hysteresis, the maximum or highest stress of HAC at 10% strain dramatically increased compared to that of SC3M3, resulting in a higher compression modulus. This confirmed the efficiency of the multizonal structure that was printed using the inks of the disclosure.

In order to evaluate and compare the capability of the printed HAC and SC3M3 to withstand many repetitions of compression loads, cyclic tests were performed up to 400 cycles, with 40 min recovery time between each 100 cycles. (FIG. 9f). As displayed in FIG. 9f, the maximum or highest stress decreases from about 82.2 to 71.3 kPa within the first 200 cycles; however, the maximum or highest stress reaches a plateau at 70 kPa during the remaining cycles, confirming that the softening effect on HAC is reversible to some extent. FIG. 9f also illustrates that the differences between highest and lowest maximum stresses of the printed HAC are much lower compared to those of SC3M3, which is in good agreement with the other mechanical test results. To examine the effect of time on the recovery features of the HAC and SC3M3, cyclic tests were performed at different time points. The results showed that all the printed structures become stiffer through time. In overall, by comparing the mechanical behaviors of the printed HAC with the human one, it is expected that the multimaterial printing using the inks of the disclosure can mimic the multizonal structure of the human AC.

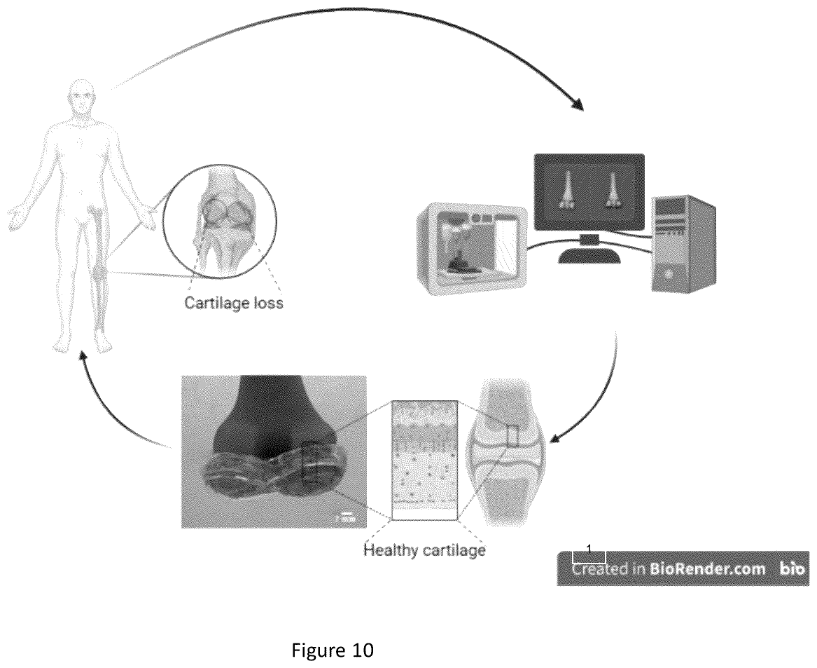

During further evaluation, a customized HAC was designed and printed to cover the femoral condyles. This process is schematically shown in FIG. 10. Based on a CT image, a scaled down femur was printed using a DLP printer. The HAC substitute was designed using a 3D software rendering program. As can be seen in FIG. 10, to show the multilayered structure of the printed HAC, both lateral and medial femoral condyles were completely covered by the first layer; however, second and third layers just cover the exterior part of the femoral head. The printed customized HAC showed the potential application of the developed inks in fabricating personalized tissue mimetic models.

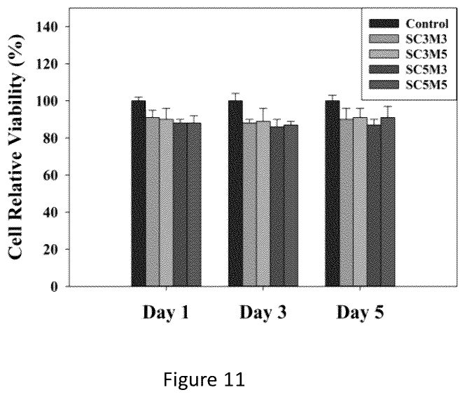

To evaluate the cytotoxicity of the developed inks, an MTT assay was performed on days 1, 3, and 5 with the results shown in FIG. 11. The results show that the inks of the disclosure were found to have no toxic effects against fibroblast cells, confirming their biocompatibility.

While various embodiments have been described above, it should be understood that they have been presented only as illustrations and examples of the present disclosure, and not by way of limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

What is claimed is:

1. A fast-curing hydrophilic silicone material with tunable viscoelastic features for forming a three-dimensional object comprising:
a hydrophilic polymer matrix;
at least one cross-linking material; and
at least one photoinitiator.

2. The fast curing hydrophilic silicone material of claim 1 wherein the hydrophilic polymer matrix comprises:
a polymer matrix; and
a set of rheology modifiers.

3. The fast curing hydrophilic silicone material of claim 2 wherein the polymer matrix is a silicone elastomer.

4. The fast curing hydrophilic silicone material of claim 3 wherein the silicone elastomer is aminosilicone or polyurethane.

5. The fast curing hydrophilic silicone material of claim 2 wherein the set of rheology modifiers comprise cellulose nanocrystal (CNC), anisotropic nanoparticles or cellulose nanofibers (CNF).

6. The fast curing hydrophilic silicone material of claim 5 wherein the set of rheology modifiers is between about 1% and about 7% by weight.

7. The fast curing hydrophilic silicone material of claim 1 wherein the at least one cross-linking material is a photoinitiator or methacrylate anhydride (MA).

8. The fast curing hydrophilic silicone material of claim 7 wherein the MA is between about 3% and about 5% by weight.

9. A method of manufacturing a fast curing hydrophilic silicone material comprising:
obtaining a hydrophilic polymer matrix; and
mixing at least one cross-linking material with the hydrophilic polymer matrix.

10. The method of claim 9 wherein obtaining a hydrophilic polymer matrix comprises:
obtaining a silicone elastomer; and
mixing a set of rheology modifiers with the silicone elastomer.

11. The method of claim 10 wherein the silicone elastomer is aminosilicone.

12. The method of claim 10 wherein the set of rheology modifiers is made from cellulose nanocrystal (CNC), cellulose nanofibers (CNF) or anisotropic nanoparticles.

13. The method of claim 10 wherein the set of rheology modifiers is between about 1% and 7% by weight of the silicone material.

14. The method of claim 9 wherein the at least one cross-linking material is a photoinitiator or methacrylate anhydride (MA).

15. The method of claim 14 wherein the MA is between about 3% and about 5% by weight of the silicone material.
